(19) United States
(12) Patent Application Publication
(10) Pub. No.: US 2015/0055170 A1
(43) Pub. Date: Feb. 26, 2015

(54) INFORMATION PROCESSING APPARATUS AND INFORMATION PROCESSING SYSTEM

(71) Applicant: FUJI XEROX CO., LTD., Tokyo (JP)

(72) Inventors: Yasushi AMANO, Kanagawa (JP); Kohshiro INOMATA, Kanagawa (JP); Fumihisa SUZUKI, Kanagawa (JP); Hirochika SHIONOIRI, Kanagawa (JP); Yosuke KINOSHITA, Kanagawa (JP)

(73) Assignee: FUJI XEROX CO., LTD., Tokyo (JP)

(21) Appl. No.: 14/267,470

(22) Filed: May 1, 2014

(30) Foreign Application Priority Data
Aug. 23, 2013 (JP) 2013-173801

(51) Int. Cl. H04N 1/40

(52) U.S. Cl. CPC H04N 1/40093
USPC 358/1.15

(57) ABSTRACT

An information processing apparatus includes a first generation unit, an acquisition unit, an identification unit, and a second generation unit. The first generation unit generates a second document resulting from deletion of first information allocated at a first position from a first document. The acquisition unit acquires a third document resulting from execution of a process to the second document generated by the first generation unit. The identification unit identifies a second position corresponding to the first position of the first document in the third document. The second generation unit generates a fourth document in which the first information is allocated at the second position identified by the identification unit in the third document acquired by the acquisition unit.

### CROSS-REFERENCE TO RELATED APPLICATIONS

This application is based on and claims priority under 35 USC 119 from Japanese Patent Application No. 2013-173801 filed Aug. 23, 2013.

### BACKGROUND

### Technical Field

The present invention relates to an information processing apparatus and an information processing system.

### SUMMARY

According to an aspect of the invention, there is provided an information processing apparatus including a first generation unit, an acquisition unit, an identification unit, and a second generation unit. The first generation unit generates a second document resulting from deletion of first information allocated at a first position from a first document. The acquisition unit acquires a third document resulting from execution of a process to the second document generated by the first generation unit. The identification unit identifies a second position corresponding to the first position of the first document in the third document. The second generation unit generates a fourth document in which the first information is allocated at the second position identified by the identification unit in the third document acquired by the acquisition unit.

### BRIEF DESCRIPTION OF THE DRAWINGS

Exemplary embodiments of the present invention will be described in detail based on the following figures, wherein:

FIG. 1 illustrates an exemplary configuration of an information processing system according to an exemplary embodiment of the present invention;

FIG. 2 illustrates an exemplary hardware configuration of an image processing apparatus according to the present exemplary embodiment;

FIG. 3 is an exemplary conceptual diagram for describing an outline of processing in the image processing apparatus 100 according to the present exemplary embodiment;

FIG. 4 illustrates an example of a transmission sentence format database of the present exemplary embodiment;

FIG. 5 illustrates an example of a deletion table of the present exemplary embodiment;

FIG. 6 illustrates an example of a reception sentence format database of the present exemplary embodiment;

FIG. 7 is a flowchart illustrating an exemplary operational process in an original determiner of the present exemplary embodiment;

FIG. 8 is a flowchart illustrating an exemplary operational process in a transmission sentence generator of the present exemplary embodiment;

FIG. 9 illustrates an example of an original of the present exemplary embodiment;

FIG. 10 illustrates an example of a transmission sentence acquired from the original illustrated in FIG. 9;

FIG. 11 is a flowchart illustrating an exemplary operational process in a processed sentence generator of the present exemplary embodiment;

FIG. 12 illustrates an example of a reception sentence of the present exemplary embodiment; and

FIG. 13 illustrates an example of a processed sentence acquired from the reception sentence illustrated in FIG. 12.

### DETAILED DESCRIPTION

### 1. Exemplary Embodiments

### 1-1. Configuration

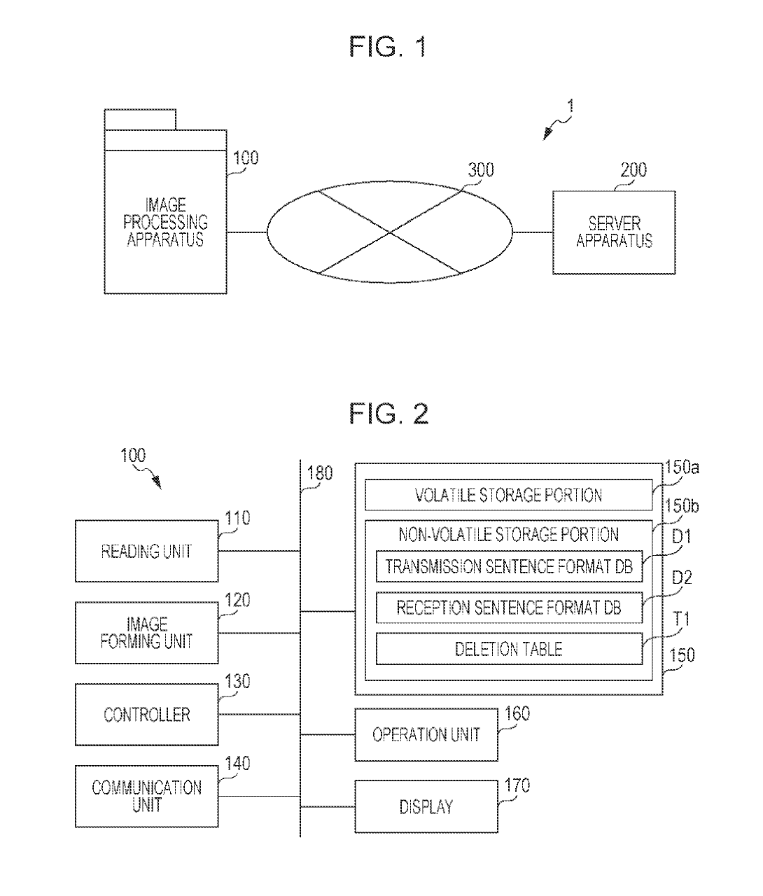

FIG. 1 illustrates an exemplary configuration of an information processing system 1 according to an exemplary embodiment of the present invention. Referring to FIG. 1, an image processing apparatus 100 is an information processing apparatus according to an exemplary embodiment and has a function to request an external server apparatus 200 to perform a process, in addition to a copy function, a scanner function, and a printer function. The image processing apparatus 100 is connected to the external server apparatus 200 via the Internet 300. The server apparatus 200 has a function to receive data from the image processing apparatus 100, which is a client apparatus, execute a process requested in the received data, and return data indicating the result of the process. Although one image processing apparatus 100 and one server apparatus 200 are illustrated in FIG. 1 for simplicity, the information processing system 1 may include multiple image processing apparatuses 100 and multiple server apparatuses 200.

FIG. 2 illustrates an exemplary hardware configuration of the image processing apparatus 100 according to the present exemplary embodiment. Referring to FIG. 2, the image processing apparatus 100 includes a reading unit 110, an image forming unit 120, a controller 130, a communication unit 140, a memory 150, an operation unit 160, and a display 170. The reading unit 110 reads out an image of a document. The image forming unit 120 forms an image on a sheet (a medium) in accordance with image data that is supplied. The communication unit 140 is used to communicate with an external apparatus. The controller 130 controls each component via a bus 180.

The memory 150 includes a volatile storage portion 150a and a non-volatile storage portion 150b, as illustrated in FIG. 2. The volatile storage portion 150a is a storage device, such as a random access memory (RAM), the content of storage of which disappears without supply of power. The volatile storage portion 150a is used as a working area by the controller 130 that operates in accordance with software. In contrast, the non-volatile storage portion 150b is a storage device, such as a hard disk, the content of storage of which does not disappear even without supply of power. The non-volatile storage portion 150b stores a transmission sentence format database (the “database” is hereinafter denoted by a “DB” in the drawings) D1 and a reception sentence format database D2 of the present exemplary embodiment and has an area in which a deletion table T1 is stored. The non-volatile storage portion 150b also stores a program in which a procedure to execute information processing according to an exemplary embodiment is defined.

The controller 130 is, for example, a central processing unit (CPU). The controller 130 supplies image data that is read out by the reading unit 110 to an external apparatus with the communication unit 140 to cause the image processing apparatus 100 to function as a scanner. In addition, the controller 130 outputs an image corresponding to image data that is read out by the reading unit 110 with the image forming unit 120 to cause the image processing apparatus 100 to function as a copier. Furthermore, the controller 130 outputs an image corresponding to data that is externally supplied with the image forming unit 120 to cause the image processing apparatus 100 to function as a printer.

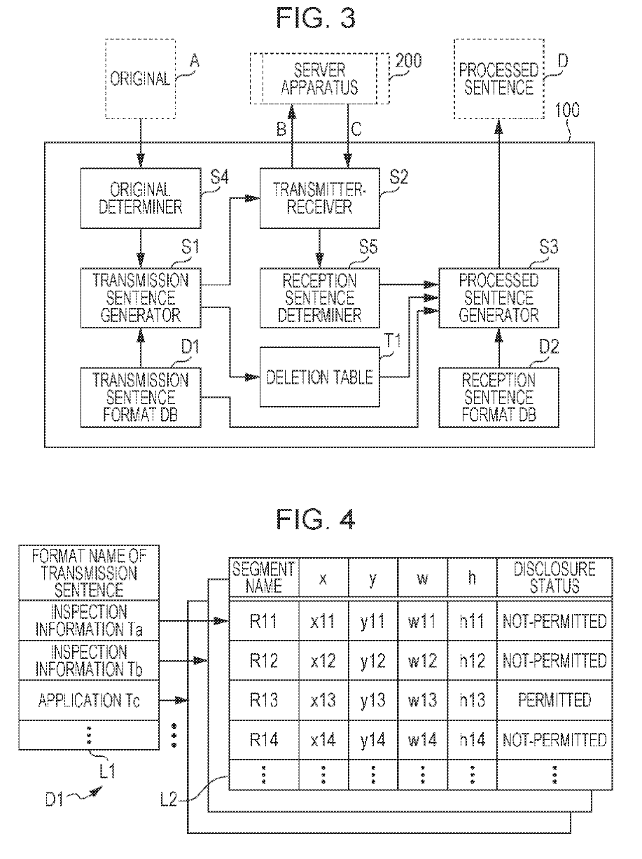

FIG. 3 is an exemplary conceptual diagram for describing an outline of processing in the image processing apparatus 100 according to the present exemplary embodiment. The controller 130 in the image processing apparatus 100 functions as a transmission sentence generator S1, a transmitter-receiver S2, a processed sentence generator S3, an original determiner S4, and a reception sentence determiner S5 illustrated in FIG. 3.

The original determiner S4 checks the content of an original A that is read out by the reading unit 110 in the image processing apparatus 100 to determine whether the original A is a document created in accordance with any predetermined format (such a document is hereinafter referred to as a “fixed form document”). For example, the original determiner S4 determines whether the original A is the fixed form document on the basis of an image at a predetermined position, such as a lower right portion, in the original A that is read out by the reading unit 110. The image may be an image representing a character string, such as “Ta”, indicating the format name of the fixed form document or may be a barcode indicating the format name of the fixed form document.

The transmission sentence generator S1 refers to the transmission sentence format database D1 (described in detail below with reference to FIG. 4) stored in the non-volatile storage portion 150b to identify information allocated in a predetermined segment in the original A determined to be the fixed form document by the original determiner S4 as specific information to be deleted. Then, the transmission sentence generator S1 generates a transmission sentence B having the content resulting from deletion of the identified specific information from the original A and generates the deletion table T1 in which the specific information is associated with the name (hereinafter referred to as a segment name) of the segment in which the specific information has been described in the original A. The specific information is an example of first information, the original A is an example of a first document, and the transmission sentence B is an example of a second document.

The transmission sentence B may not be generated by the deletion of the specific information from the original A as long as the transmission sentence B has the above content. For example, the transmission sentence B may be generated by extracting information other than the specific information from the original A. In this case, for example, the controller 130 may divide the original A into segments, may determine whether the disclosure of each segment is permitted, and may duplicate only the segment or segments the disclosure of which is permitted to generate the transmission sentence B.

The transmitter-receiver S2 transmits the transmission sentence B generated by the transmission sentence generator S1 to the server apparatus 200 via the communication unit 140. The transmitter-receiver S2 receives a document resulting from execution of a predetermined process to the transmission sentence B by the server apparatus 200 as a reception sentence C via the communication unit 140. The transmitter-receiver S2 is an example of a transmission unit that transmits the second document generated by a first generation unit to an external apparatus and an example of an acquisition unit that acquires a third document resulting from execution of a process to the second document by the external apparatus.

The reception sentence determiner S5 checks the content of the reception sentence C received by the transmitter-receiver S2 to determine whether the reception sentence C is any fixed form document. For example, the reception sentence determiner S5 determines whether the reception sentence C is the fixed form document on the basis of an image at a predetermined position, such as a lower right portion, in the reception sentence C. The image may be an image representing a character string indicating the format name of the fixed form document or may be a barcode indicating the format name of the fixed form document.

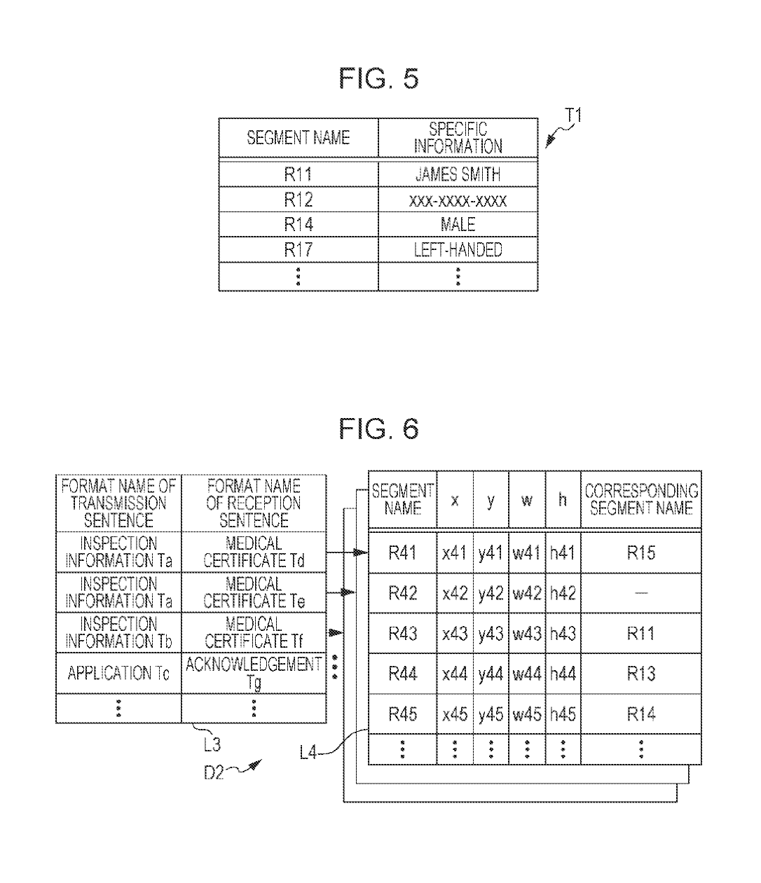

The processed sentence generator S3 refers to the deletion table T1 (described in detail below with reference to FIG. 5) and the reception sentence format database D2 (described in detail below with reference to FIG. 6) stored in the non-volatile storage portion 150b to identify a segment in the reception sentence C, corresponding to the segment from which the specific information has been deleted in the transmission sentence B, and allocates the specific information in the identified segment to generate a processed sentence D. The controller 130 causes the image forming unit 120 to output the processed sentence D generated by the processed sentence generator S3. The above processing is executed by the controller 130 in the image processing apparatus 100 which reads out the program stored in the non-volatile storage portion 150b.

FIG. 4 illustrates an example of the transmission sentence format database D1 of the present exemplary embodiment. As illustrated in FIG. 4, the transmission sentence format database D1 includes a transmission sentence format name list L1 in which the format names of transmission sentences are listed. The transmission sentence format database D1 also includes a transmission sentence segment list L2 in which, for every format indicated by each format name listed in the transmission sentence format name list L1, the segment name of each segment composing a document according to the format, the position (a horizontal scanning direction coordinate x and a vertical scanning direction coordinate y) of the segment, the size (a width w and a height h) of the segment, and information indicating whether the disclosure of the information allocated in the segment to an external apparatus is permitted (hereinafter referred to as a disclosure status) are described. One transmission sentence segment list L2 is associated with each formant name listed in the transmission sentence format name list L1. The horizontal scanning direction and the vertical scanning direction correspond to the directions of horizontal scanning and vertical scanning when an image indicating the original A is read out by the reading unit 110.

For example, in the example illustrated in FIG. 4, one transmission sentence segment list L2 is associated with a transmission sentence format name “inspection information Ta.” In the transmission sentence segment list L2, “R11”, “R12”, “R13”, “R14”, . . . are described in segment name fields and the position, the size, and the disclosure status of each segment are described in each segment name field. For example, the horizontal scanning direction coordinate of the segment indicated by the segment name “R11” is x11, the vertical scanning direction coordinate thereof is y11, the width thereof is w11, and the height thereof is h11. The disclosure status of the segment indicated by the segment name “R11” is “Not-permitted” indicating that the disclosure is not permitted. In other words, the information allocated in the segment indicated by the segment name “R11” is inhibited from being disclosed to an external apparatus.

FIG. 5 illustrates an example of the deletion table T1 of the present exemplary embodiment. One deletion table T1 is created for every original A processed by the image processing apparatus 100. The segment name of a segment to be deleted in the original A is stored in association with the specific information, which has been described in the segment, in the deletion table T1. When the image processing apparatus 100 processes multiple originals A in parallel, the image processing apparatus 100 may add identification information, such as a process number, to the process to each original A or each transmission sentence B to discriminate the processes. In this case, the deletion table T1 is created for every piece of identification information indicating each process, for example, for every process number. The deletion table T1 functions as a memory that stores the segment (a first position) indicated by each segment name in association with the specific information (the first information) which has been described in the segment in the original A on which the transmission sentence B is based, for every process which an external apparatus executes to the transmission sentence B (the second document).

In the transmission sentence format database D1, the fact that the disclosure status of the segment having the segment name “R11” is “Not-permitted” is described in the transmission sentence segment list L2 associated with the format name “inspection information Ta”, as described above. For example, when a character string “James Smith” is described in the segment having the segment name “R11” in the original A in the processing of the original A, which is the fixed form document according to the format of the format name “inspection information Ta”, by the image processing apparatus 100, the image processing apparatus 100 identifies “James Smith” as the specific information and deletes “James Smith” from the original A duplicated in the volatile storage portion 150a. Then, the image processing apparatus 100 writes “James Smith”, which is the deleted specific information, in the deletion table T1 in association with the segment name “R11” of the segment in which the deleted specific information has been allocated.

As described above, the image processing apparatus 100 sequentially deletes the pieces of information (the pieces of specific information) allocated in the segments the disclosure statuses of which are set to “Not-permitted”, among the segments in the original A, and stores the pieces of information in association with the segment names of the segments in which the pieces of information have been allocated in the original A. When all the pieces of specific information are deleted from the duplication of the original A stored in the volatile storage portion 150a, the image processing apparatus 100 transmits the duplication of the original A subjected to the processing to the server apparatus 200 as the transmission sentence B.

FIG. 6 illustrates an example of the reception sentence format database D2 of the present exemplary embodiment. As illustrated in FIG. 6, the reception sentence format database D2 includes a reception sentence format name list L3 in which the format name of the format of the reception sentence C (hereinafter referred to as a reception sentence format name) is associated with the format name of the format of the transmission sentence B (hereinafter referred to as a transmission sentence format name) to be processed by the server apparatus 200 when the reception sentence C is returned to the image processing apparatus 100. Multiple formats of the reception sentences C may be associated with one format of the transmission sentence B while one format of the transmission sentence B is associated with one format of the reception sentence C. For example, a “medical certificate Td” and a “medical certificate Te”, which are the reception sentence format names, are associated with the “inspection information Ta”, which is the transmission sentence format name. In contrast, only the “inspection information Ta”, which is the transmission sentence format name, is associated with the “medical certificate Td”, which is the reception sentence format name.

The reception sentence format database D2 also includes a reception sentence segment list L4 in which the segment name of each segment composing the reception sentence C according to the format indicated by the reception sentence format name, the position (the horizontal scanning direction coordinate x and the vertical scanning direction coordinate y) of the segment, the size (the width w and the height h) of the segment, and the segment name (hereinafter referred to as a “corresponding segment name”) of the segment (hereinafter referred to as a “corresponding segment”) corresponding to the segment in the transmission sentence B before the reception sentence C is processed by the server apparatus 200 are described. One reception sentence segment list L4 is associated with each format name listed in the reception sentence format name list L3.

For example, in the example illustrated in FIG. 6, the transmission sentence format name “inspection information Ta” is associated with the reception sentence format name “medical certificate Td” and one reception sentence segment list L4 is associated with the reception sentence format name “medical certificate Td.” In the reception sentence segment list L4, “R41”, “R42”, “R43”, “R44”, . . . are described in segment name fields and the position of the segment, the size of the segment, and the corresponding segment name are described in each segment name field. For example, the horizontal scanning direction coordinate of the segment indicated by the segment name “R41” is x41, the vertical scanning direction coordinate thereof is y41, the width thereof is w41, and the height thereof is h41. The corresponding segment name of the transmission sentence format name “inspection information Ta”, corresponding to the segment name “R41” of the reception sentence format name “medical certificate Td” is “R15.” This means that the information described in the segment indicated by the corresponding segment name “R15” of the transmission sentence B is processed in the server apparatus and is described in the segment indicated by the segment name “R41” in the reception sentence C.

When “-” is described as the corresponding segment name of the segment corresponding to a segment in the reception sentence C, this means that no corresponding segment exists in the transmission sentence B for the segment in the reception sentence C. In this case, the server apparatus 200 generates information to be described in the segment in the reception sentence C independent of the information described in any segment in the transmission sentence B.

### 1-2. Operations

### (1) Operation of Original Determiner

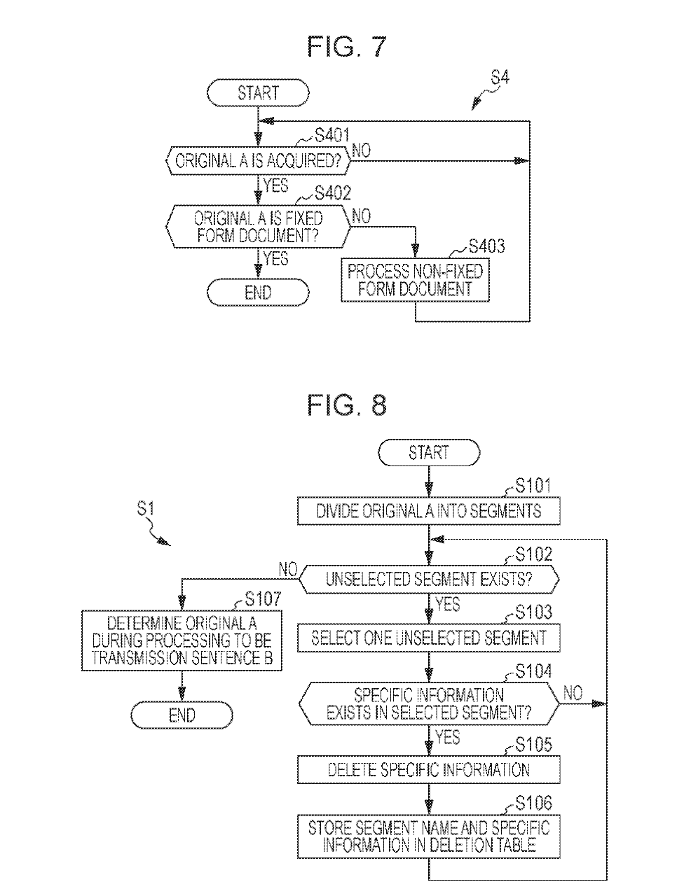

FIG. 7 is a flowchart illustrating an exemplary operational process in the original determiner S4 of the present exemplary embodiment. A user of the image processing apparatus 100 sets a document of the original A including inspection information about a body, which is an image captured by computed tomography or the like, in an automatic document feeder (not illustrated) of the reading unit 110 in the image processing apparatus 100. The user operates the operation unit 160 to display a menu screen. The user selects “Image analysis” from the menu. Upon selection of the “Image analysis”, a screen for detailed setting of the image analysis is displayed in the display 170. The user operates the operation unit 160 to specify the kind of the image analysis or to specify the server apparatus 200 which the image processing apparatus 100 requests to perform the image analysis from multiple candidates.

Referring to FIG. 7, in Step S401, the controller 130 determines whether the original A is acquired. While the controller 130 determines that the original A is not acquired (NO in Step S401), the controller 130 continues the determination. Upon pressing of a “Start” button in the operation unit 160 by the user, the controller 130 outputs an instruction to convey the document of the original A set in the automatic document feeder of the reading unit 110 to a reading position for scanning. As a result, the document of the original A is read out by the reading unit 110 to generate image data representing the image read out from the document. Upon generation of the image data, the controller 130 determines that the original A is acquired (YES in Step S401). In Step S402, the controller 130 determines whether the acquired original A is the fixed form document on the basis of, for example, an image written in a predetermined position. If the controller 130 determines that the original A is the fixed form document (YES in Step S402), the process in the original determiner S4 is terminated. Then, the controller 130 starts an operational process in the transmission sentence generator S1. If the controller 130 determines that the original A is not the fixed form document (NO in Step S402), in Step S403, the controller 130 performs a process to a document that is not the fixed form document (such a document is hereinafter referred to as a “non-fixed form document”). Then, the process goes back to Step S401 to wait for acquisition of the next original A. The process to the non-fixed form document in Step S403 may be a process in which the original A, which is determined not to be the fixed form document, is directly transmitted to the server apparatus 200 to request the server apparatus 200 to perform the image analysis or may be a process in which the image processing apparatus 100 warns the user that the original A is not the fixed form document. The process to the non-fixed form document in Step S403 may be a process in which the operation for the original A determined not to be the fixed form document is stopped to store an error log.

### (2) Operation of the Transmission Sentence Generator

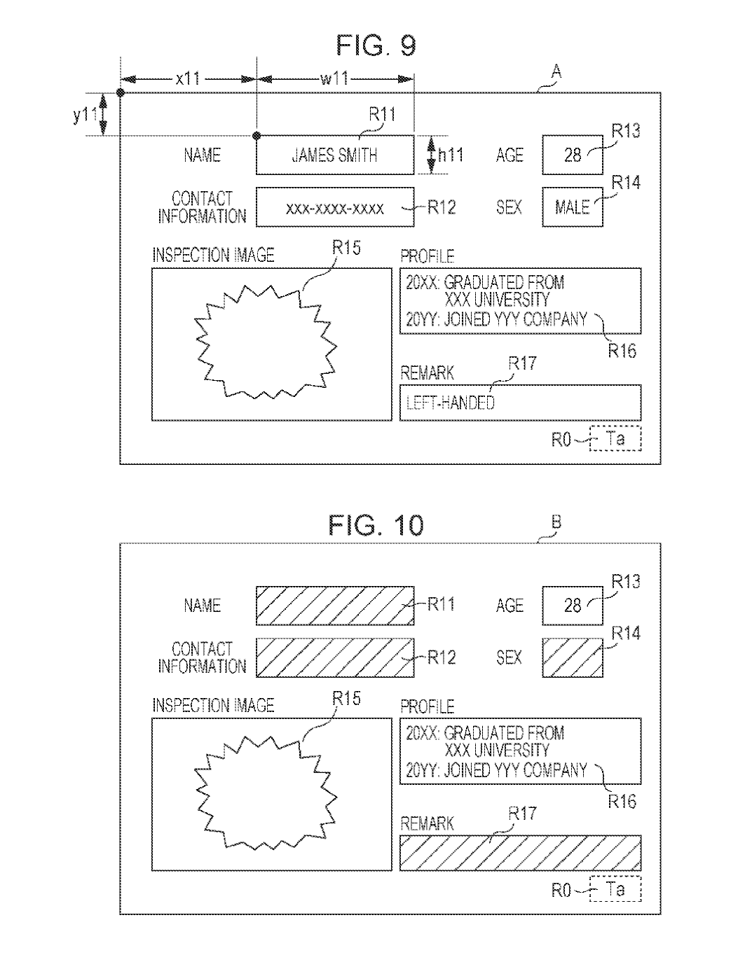

FIG. 8 is a flowchart illustrating an exemplary operational process in the transmission sentence generator S1 of the present exemplary embodiment. FIG. 9 illustrates an example of the original A of the present exemplary embodiment. If the controller 130 determines in the operational process in the original determiner S4 that the original A is the fixed form document, the controller 130 moves to the operational process in the transmission sentence generator S1. The controller 130 stores a duplication of the original A, which is the fixed form document, in the volatile storage portion 150a. The original A that is duplicated is hereinafter referred to as an “original A during processing.” The controller 130 searches the format names listed in the transmission sentence format name list L1 for the format name of the original A by referring to the transmission sentence format database D1 to identify the transmission sentence segment list L2 corresponding to the format name.

Referring to FIG. 8, in Step S101, the controller 130 divides the original A into segments on the basis of the transmission sentence segment list L2. Specifically, the controller 130 extracts each segment indicated by the horizontal scanning direction coordinate x, the vertical scanning direction coordinate y, the width w, and the height h described in the transmission sentence segment list L2, among the pieces of image data about the original A. Here, the controller 130 may not practically divide the image data and may associate the position and the size of the segment described in the transmission sentence segment list L2 with the image data. The controller 130 may identify the position and the size of each entry field in the image data about the original A that is scanned by a labeling process or an edge detection process and compares the position and the size of the entry field with the position and the size of the segment described in the transmission sentence segment list L2 to associate the position and the size of the entry field with the position and the size of the segment described in the transmission sentence segment list L2. This allows a shift in the position and/or a shift in the size, which are caused by the scanning, to be corrected.

In Step S102, the controller 130 determines whether any segment that is not selected in Step S103 described below, that is, any unselected segment exists in the segments resulting from the division. If the controller 130 determines that any unselected segment exists (YES in Step S102), in Step S103, the controller 130 selects one unselected segment. In Step S104, the controller 130 determines whether the disclosure status of the selected segment is set to “Non-permitted” in the transmission sentence segment list L2, that is, the controller 130 determines whether the specific information exists in the selected segment.

If the controller 130 determines that the specific information exists in the original A during processing (YES in Step S104), in Step S105, the controller 130 deletes the specific information from the original A during processing. In Step S106, the controller 130 stores the segment name of the segment in which the deleted specific information has been described is stored in the deletion table T1 in association with the deleted specific information. Then, the process goes back to Step S102.

If the controller 130 determines that the unselected segment does not exist (NO in Step S102), in Step S107, the controller 130 determines the original A during processing to be the transmission sentence B. Then, the process in the transmission sentence generator S1 is terminated.

In the storage in the deletion table T1, the image indicating the specific information may be subjected to a character recognition process to store the character sequence data subjected to the character recognition process in the deletion table T1.

For example, when the transmission sentence generator S1 refers to the transmission sentence format database D1 illustrated in FIG. 4 to perform the process to the original A illustrated in FIG. 9, the format of the original A is “Ta”, that is the “inspection information Ta”, as described in a segment R0 in FIG. 9. In the transmission sentence format database D1, “R11”, “R12”, “R14”, . . . are described in the transmission sentence segment list L2 associated with the inspection information Ta as the segments the disclosure statuses of which are “Not-permitted, that is, as the segment names indicating the segments for which the disclosure is not permitted. The controller 130 identifies the segments for which the disclosure is not permitted from the segment names (Step S104) and deletes the pieces of information allocated in the segments, that is, “James Smith”, “xxx-xxxx-xxxx”, “Male”, and so on from the original A during processing as the specific information (Step S105). If the pieces of specific information are deleted and no specific information exists in the original A during processing or if the determination of whether the specific information is included is finished for all the divided segments of the original A (NO in Step S102), the controller 130 determines the original A during processing including no specific information to be the transmission sentence B (Step S107). Upon determination of the transmission sentence B, the controller 130 functioning as the transmitter-receiver S2 transmits the transmission sentence B to the server apparatus 200.

FIG. 10 illustrates an example of the transmission sentence B acquired from the original A illustrated in FIG. 9. Referring to FIG. 10, hatches segments R11, R12, R14, and R17 indicate segments the information allocated in which has been deleted because of the specific information. Since the information that has been allocated in the segments in the original A before the processing is not included in the transmission sentence B to be transmitted to the server apparatus 200, the information is not disclosed to the server apparatus 200.

The controller 130 stores the deleted specific information in the deletion table T1 in association with the segment name of the segment in which the specific information has been allocated (Step S106). When the transmission sentence generator S1 performs the process to the original A illustrated in FIG. 9, the deletion table T1 in which “James Smith” associated with the segment name “R11”, “xxx-xxxx-xxxx” associated with the segment name “R12”, and “Male” associated with the segment name “R14” are stored is generated, as illustrated in FIG. 5.

### (3) Operation of the Processed Sentence Generator

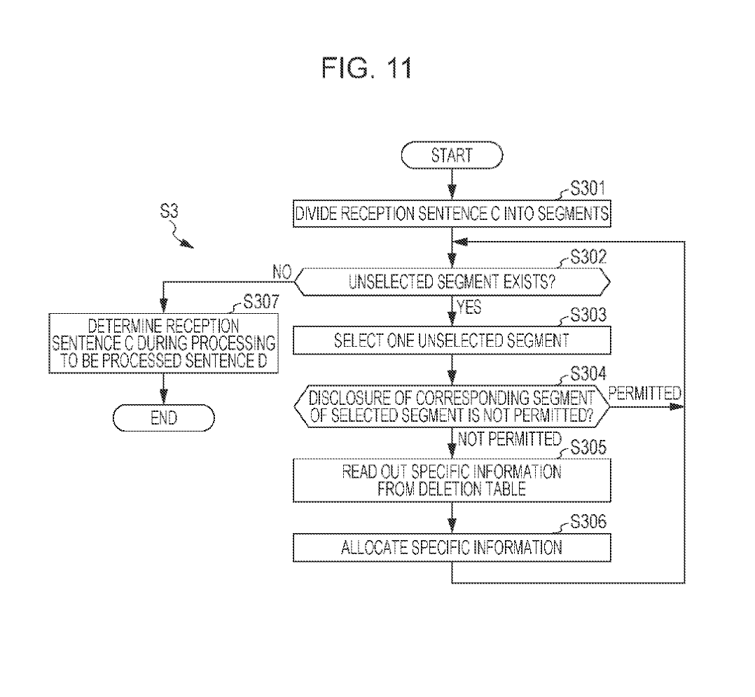

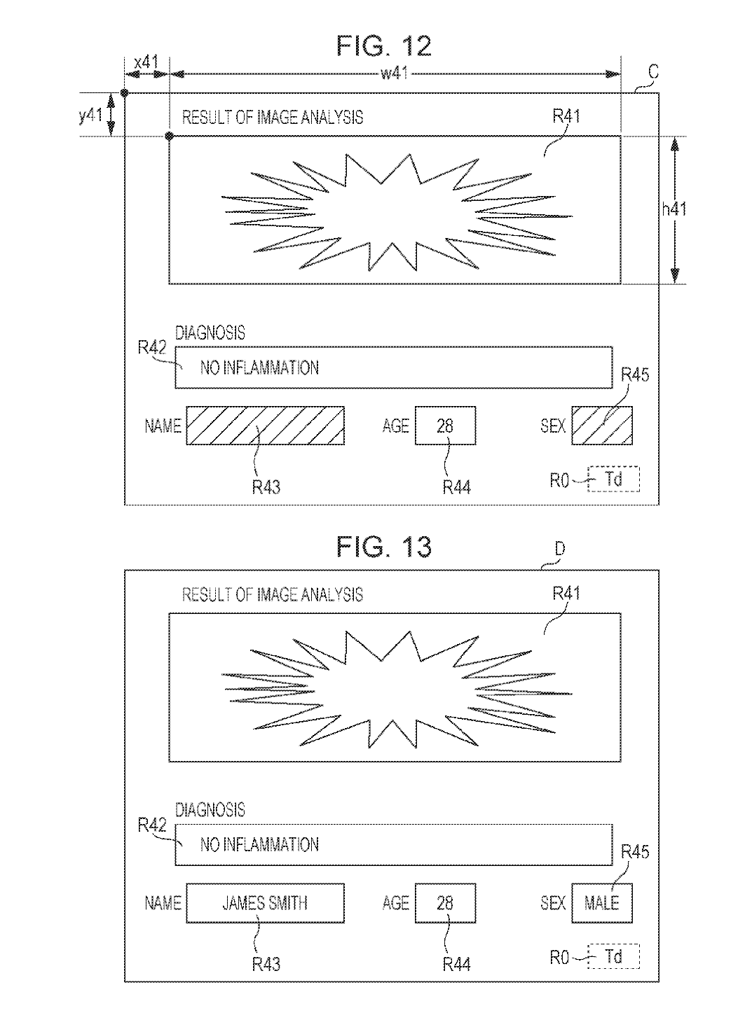

FIG. 11 is a flowchart illustrating an exemplary operational process in the processed sentence generator S3 of the present exemplary embodiment. FIG. 12 illustrates an example of the reception sentence C of the present exemplary embodiment. Nothing is described in hatched segments R43 and R45 in FIG. 12. This is because the specific information is allocated in these segments by the processed sentence generator S3 and it is not necessary for the server apparatus 200 to allocate information in these segments prior to the allocation of the specific information by the processed sentence generator S3.

The controller 130 in the image processing apparatus 100 executes the processes of the transmitter-receiver S2 and the reception sentence determiner S5 before executing the process of the processed sentence generator S3, as illustrated in FIG. 3. Specifically, the controller 130 receives the data acquired from the server apparatus 200 that executes the process to the transmission sentence B as the reception sentence C and stores a duplication of the received reception sentence C in the volatile storage portion 150a. The reception sentence C that is duplicated is hereinafter referred to as a “reception sentence C during processing.” The controller 130 searches the format names listed in the reception sentence format name list L3 for the format name of the reception sentence C during processing by referring to the reception sentence format database D2 to identify the reception sentence segment list L4 corresponding to the format name.

Referring to FIG. 11, in Step S301, the controller 130 divides the reception sentence C during processing into segments on the basis of the reception sentence segment list L4. Specifically, the controller 130 extracts each segment indicated by the horizontal scanning direction coordinate x, the vertical scanning direction coordinate y, the width w, and the height h described in the reception sentence segment list L4, in the data about the reception sentence C. Here, the controller 130 may not practically divide the data and may associate the position and the size of the segment described in the reception sentence segment list L4 with the data.

In Step S302, the controller 130 determines whether any segment that is not selected in Step S303 described below exists in the segments resulting from the division, that is, whether any unselected segment exists in the reception sentence C during processing. If the controller 130 determines that any unselected segment exists (YES in Step S302), in Step S303, the controller 130 selects one unselected segment. In Step S304, the controller 130 refers to the reception sentence format database D2 to identify the corresponding segment name associated with the selected segment and refers to the transmission sentence format database D1 to determine whether the disclosure of the corresponding segment indicated by the corresponding segment name is not permitted. If the controller 130 determines that the disclosure of the corresponding segment is permitted (PERMITTED in Step S304), the process goes back to Step S302. If the controller 130 determines that the disclosure of the corresponding segment is not permitted (NOT PERMITTED in Step S304), in Step S305, the controller 130 refers to the deletion table T1 to read out the specific information that is stored in association with the corresponding segment. In Step S306, the controller 130 allocates the specific information that is read out in the segment in the reception sentence C during processing. Then, the process goes back to Step S302.

The controller 130 may execute the following processing, instead of Step S304 described above. Specifically, the controller 130 may identify the corresponding segment name of the corresponding segment associated with the segment selected in Step S303 by referring to the reception sentence format database D2 to search the deletion table T1 for a line in which the corresponding segment name is described. If the controller 130 finds the corresponding segment name in the deletion table T1, the controller 130 may read out the specific information that is associated with the corresponding segment name (Step S305) and may allocate the specific information that is read out in the selected segment in the reception sentence C (Step S306).

When the corresponding segment name identified by the reference to the reception sentence format database D2 is “-” indicating that no corresponding segment exists in the transmission sentence B, the controller 130 may execute the same processing as in the case in which the controller 130 determines that the disclosure of the corresponding segment is permitted (PERMITTED in Step S304).

If the controller 130 determines that no unselected segment exists (NO in Step S302), in Step S307, the controller 130 determines the reception sentence C during processing to be the processed sentence D. An image of the processed sentence D that is determined is formed on a sheet (a medium) by the image forming unit 120 to be output.

For example, the format of the reception sentence C illustrated in FIG. 12 is “Td”, that is, the “medical certificate Td”, as described in the segment R0. The controller 130 divides the reception sentence C into segments (Step S301) and sequentially selects each segment (Steps S302 and S303).

The controller 130 refers to the reception sentence format name list L3 in the reception sentence format database D2 illustrated in FIG. 6 to identify the transmission sentence format name “inspection information Ta” associated with the “medical certificate Td.” The controller 130 refers to the reception sentence segment list L4 associated with the reception sentence format name “medical certificate Td” in the reception sentence format database D2 illustrated in FIG. 6 to identify the corresponding segment name associated with the selected segment. Specifically, for example, the controller 130 identifies “R11” as the corresponding segment name of the segment “R43” and identifies “R13” as the corresponding segment name of the segment “R44.”

The controller 130 reads out the transmission sentence segment list L2 associated with the transmission sentence format name “inspection information Ta” by referring to the transmission sentence format database D1 illustrated in FIG. 4 to determine whether the disclosure of the segment indicated by the corresponding segment name in the transmission sentence segment list L2 is not permitted. For example, the controller 130 refers to the transmission sentence segment list L2 of the format name “inspection information Ta” to determine that the disclosure of the segment indicated by the corresponding segment name “R11” is not permitted and to determine that the disclosure of the segment indicated by the corresponding segment name “R13” is permitted.

The controller 130 searches the deletion table T1 for the segment name of the segment the disclosure of which is not permitted to read out the specific information that is stored in the deletion table T1 with the segment name that is searched for. For example, the controller 130 searches the deletion table T1 for the segment name “R11” to read out the specific information “James Smith.” The controller 130 allocates the specific information that is read out in the selected segment in the reception sentence C during processing. Specifically, the specific information “James Smith” is allocated in the segment “R43.” The specific information that has been described in the segment the disclosure of which is not permitted in the original A is allocated in the corresponding segment in the reception sentence C in the above manner to generate the processed sentence D. FIG. 13 illustrates an example of the processed sentence D acquired from the reception sentence C illustrated in FIG. 12.

As described above, the user is capable of receiving an external image analysis service without disclosing the specific information by setting a document on which an original is described in the image processing apparatus 100 and pressing the button to specify the image analysis. The image processing apparatus 100 according to the exemplary embodiment may be provided in, for example, a convenience store.

### 2. Modifications

The exemplary embodiments described above may be modified in the following manner. Combinations of the modifications may be adopted.

### 2-1. First Modification

Although the modes in which the image processing apparatus 100 is used as a terminal are described in the above exemplary embodiments, the terminal is not limited to the image processing apparatus 100 and may be, for example, a personal computer, a personal digital assistant (PDA), a mobile phone, a mobile music player, a mobile movie player, a game machine, an electronic book browser, or a navigation apparatus.

The network intermediating between the image processing apparatus 100 and the server apparatus 200 is not limited to the Internet 300 and may be a network, such as a local area network (LAN) or a wide area network (WAN). These networks may partially or entirely include wireless areas.

### 2-2. Second Modification

Although the modes in which the user of the image processing apparatus 100, which is a terminal, sets a document and operates the operation unit 160 to specify the image analysis are described in the above exemplary embodiments, the above processing may be executed in response to a request to the external server apparatus 200 for the image analysis in other modes. In this case, in addition to the indication of the processing with the operation of the operation unit 160 in the image processing apparatus 100, the processing may be indicated by the content of a document (directions) in which processing instructions are described in, for example, Extensible Markup Language (XML).

### 2-3. Third Modification

Although the configuration in which the user of the image processing apparatus 100, which is a terminal, operates the touch panel to request the external server apparatus 200 to perform the image analysis is described in the above exemplary embodiments, the terminal, such as a personal computer or a PDA, may be connected to the image processing apparatus 100 wirelessly or in a wired manner and the original A may be transmitted from the terminal to the image processing apparatus 100 to operate the image processing apparatus 100. In this case, the image data indicating the original A may not be the image data representing the image that is read out from the document by the reading unit 110.

### 2-4. Fourth Modification

Although the disclosure status is held in the transmission sentence format database D1 in the above exemplary embodiments, the disclosure status is not limitedly held in the transmission sentence format database D1. For example, the user may select the disclosure status of each segment when the user operates the operation unit 160 to request the external server apparatus 200 to perform the image analysis.

### 2-5. Fifth Modification

Although the specific information is deleted from the original A during processing in the above exemplary embodiments, the specific information may not limitedly deleted from the original A during processing as long as the specific information is not referred to in an external apparatus. For example, a segment that is not to be disclosed may be colored with a specific color, may be overwritten with a specific image, or may be replaced with a predetermined character string. It is sufficient for the specific information included in the original A not to be included in the transmission sentence B.

### 2-6. Sixth Modification

Although no processing is performed in the transmission sentence generator S1 since the transmission to the server apparatus 200 before the reception from the server apparatus 200 in the above exemplary embodiments, multiple transmission sentences B may be generated since the transmission to the server apparatus 200 before the reception from the server apparatus 200. In this case, an identifier (ID) representing the transmission sentence B or an ID representing the processing number may be recorded in the deletion table T1 and the ID may be referred to in the reception to find the deletion table T1.

### 2-7. Seventh Modification

Although either of “Permitted” indicating that the disclosure is permitted and “Not-permitted” indicating that the disclosure is not permitted is described in the transmission sentence format database D1 as the disclosure status of each segment in the above exemplary embodiments, the disclosure status may be set to three or more levels. For example, three levels: “Low”, “Medium”, and “High” may be set as the disclosure status of each segment. In this case, for example, the image processing apparatus 100 may not perform the deletion to segments the disclosure statuses of which are set to “Low”, may perform encryption to segments the disclosure statuses of which are set to “Medium”, and may perform the deletion to segments the disclosure statuses of which are set to “High.” Alternatively, the disclosure status may be determined for every kind of the processing which the server apparatus 200 is requested to perform or for every identification information about the server apparatus 200 or the disclosure status may be determined depending on the degree of safety of the communication line with the server apparatus 200. For example, in the case of a communication line using an encryption protocol, such as a secure sockets layer (SSL), the processing via the communication line may be determined to be safe and the disclosure status of the communication line may be set to “Low.”

### 2-8. Eighth Modification

Although the image processing apparatus 100 requests an external apparatus to perform the image analysis in the above exemplary embodiments, the image processing apparatus 100 may request the external apparatus to perform another process. For example, the image processing apparatus 100 may request the external apparatus to perform a process concerning application of a cash card or a process concerning translation, statistics, or technical calculation.

For example, when the image processing apparatus 100 requests an external apparatus to “translate English into Japanese”, the specific information in English should be translated into Japanese. In this case, the controller 130 in the image processing apparatus 100 refers to, for example, a Japanese dictionary (not illustrated) stored in the non-volatile storage portion 150b to identify “hidarikiki”, which is a Japanese translation of “left-handed”, for the specific information “left-handed” in the deletion table T1 illustrated in FIG. 5. The controller 130 allocates the identified Japanese translation in the segment in the reception sentence C, corresponding to the segment in which the specific information “left-handed” has been described in the original A. Since the same processing is performed to the specific information and other information in the processed sentence D generated in the above manner, it is possible to keep the uniformity in the document after the processing.

The image processing apparatus 100 may internally perform the same processing as the one which the image processing apparatus 100 requests the external apparatus to perform to the deleted specific information. Specifically, the information may be varied depending on the content of the processing which the image processing apparatus 100 requests the external apparatus to perform. However, since the external apparatus is not capable of acquiring the deleted specific information, it is not possible for the external apparatus to perform the processing to the specific information. When the image processing apparatus 100 simply allocates the specific information in the corresponding segment in the reception sentence C after the processing, corresponding to the segment the disclosure of which is not permitted in the original A, the specific information that is not processed remains in the processed sentence D. Accordingly, in the generation of the processed sentence D from the reception sentence C, the image processing apparatus 100 of the eighth modification internally performs the same processing as the one which the image processing apparatus 100 requests the external apparatus to perform to the specific information to allocate the specific information after the processing in the corresponding segment, instead of simply allocating the specific information in the corresponding segment. In other words, the image processing apparatus 100 of the eighth modification allocates the information, which is acquired by the image processing apparatus 100 that performs the processing to the specific information, in the corresponding segment in the reception sentence C to generate the processed sentence D.

### 2-9. Ninth Modification

Although the controller 130 functioning as the original determiner S4 and the reception sentence determiner S5 determines whether the original A read out by the reading unit 110 or the reception sentence C received from the server apparatus 200 via the communication unit 140 is the fixed form document on the basis of an image at a predetermined position, such as a lower right portion, of the original A or the reception sentence C in the above exemplary embodiments, the controller 130 may determine whether the original A or the reception sentence C is the fixed form document by another method. For example, the controller 130 may detect the position and the size of each entry field allocated in the image data by, for example, the edge detection process and may compare information about the arrangement and the number of the entry fields that are detected with information about the arrangement and the number of the entry fields in a predetermined form to determine whether the image data is the fixed form document. In this case, even when the position and the size of each entry field do not coincide with the position and the size of the segment described in the transmission sentence segment list L2 or the reception sentence segment list L4, it may be determined that the position and the size of the entry field coincide with the position and the size of the segment described in the transmission sentence segment list L2 or the reception sentence segment list L4 if the difference between them is within a predetermined range.

### 2-10. Tenth Modification

Although the image processing apparatus 100 identifies the information allocated in a predetermined segment in the original A as the specific information to be deleted to generate the transmission sentence B having the content resulting from deletion of the identified specific information from the original A in the above exemplary embodiments, the image processing apparatus 100 may generate a sentence having the content resulting from deletion of the specific information and information (hereinafter referred to as accompanying information) that is included in the original A and that is not allocated in any segment from the original A as the transmission sentence B. In other words, in the tenth modification, the transmission sentence B (the second document) has the content resulting from deletion of the specific information (the first information) and the accompanying information (second information) that is not allocated in any segment in the display of the original A (the first document) from the original A.

For example, some digital still cameras have a function to include information indicating the date and time when a picture is taken and the location where the picture is taken in image data of the picture as the accompanying information. Tags or the likes to include the accompanying information that is not displayed in a document are prepared in some markup languages, such as Hypertext Markup Language (HTML). The image processing apparatus 100 of the tenth modification identifies part or all of the accompanying information in the original A as the information to be deleted, in addition to the identification of the information to be allocated in a predetermined segment in the display of the original A as the specific information. The image processing apparatus 100 of the tenth modification generates a new transmission sentence B having the content resulting from deletion of the specific information and the information identified as the information to be deleted from the original A to transmit the generated transmission sentence B to the server apparatus 200. In this case, upon reception of the reception sentence C, the image processing apparatus 100 may identify the corresponding segment in the reception sentence C, corresponding to the segment from which the specific information has been deleted in the transmission sentence B, to allocate the specific information in the corresponding segment and may include the accompanying information deleted from the transmission sentence B in the reception sentence C. In other words, in this case, the processed sentence generator S3 (a second generation unit) realized by the controller 130 in the image processing apparatus 100 allocates the specific information (the first information) in the corresponding segment (a second position) in the reception sentence C (the third document) and generates the processed sentence D (a fourth document) including the accompanying information (the second information).

Although the processed sentence generator S3 generates the processed sentence D including the accompanying information, the included accompanying information may be allocated in any segment in the display of the processed sentence D or may be allocated in no segment. When the transmission sentence generator S1 generates the transmission sentence B (the second document) having the content resulting from deletion of the specific information (the first information) allocated in the predetermined segment (the first position) in the original A (the first document) to transmit the generated transmission sentence B to the server apparatus 200, the processed sentence generator S3 may include the specific information (the first information) in the reception sentence C (the third document) received from the server apparatus 200 as new accompanying information to generate the processed sentence D (the fourth document).

### 2-11. Eleventh Modification

Each program executed by the controller 130 may be provided in a state in which the program is stored in a computer-readable recording medium, which is, for example, a magnetic recording medium such as a magnetic tape or a magnetic disk, an optical recording medium such as an optical disk, a magneto-optical recording medium, or a semiconductor memory. The program may be downloaded via a network such as the Internet. Various apparatuses other than the CPU may be applied to the controller exemplified by the controller 130 described above and, for example, a dedicated processor may be used as the controller.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a first generation unit that generates a second document resulting from deletion of first information allocated at a first position from a first document;
an acquisition unit that acquires a third document resulting from execution of a process to the second document generated by the first generation unit;
an identification unit that identifies a second position corresponding to the first position of the first document in the third document; and
a second generation unit that generates a fourth document in which the first information is allocated at the second position identified by the identification unit in the third document acquired by the acquisition unit.

2. The information processing apparatus according to claim 1, further comprising:
a memory that stores the first position in association with the first information for every process executed to the second document.

3. The information processing apparatus according to claim 1,
wherein the second document has a content resulting from deletion of the first information and second information that is not allocated in any segment in display of the first document from the first document, and
wherein the second generation unit allocates the first information at the second position in the third document and generates the fourth document including the second information.

4. The information processing apparatus according to claim 2,
wherein the second document has a content resulting from deletion of the first information and second information that is not allocated in any segment in display of the first document from the first document, and
wherein the second generation unit allocates the first information at the second position in the third document and generates the fourth document including the second information.

5. The information processing apparatus according to claim 1, further comprising:
a transmission unit that transmits the second document generated by the first generation unit to an external apparatus; and
a determination unit that determines whether the external apparatus is safe with respect to a predetermined criterion,
wherein the acquisition unit acquires the third document resulting from execution of a process to the second document by the external apparatus, and
wherein the first generation unit generates the second document having the content of the first document if the determination unit determines that the external apparatus is safe with respect to the predetermined criterion and generates the second document having the content resulting from deletion of the first information from the first document if the determination unit determines that the external apparatus is not safe with respect to the predetermined criterion.

6. The information processing apparatus according to claim 2, further comprising:
a transmission unit that transmits the second document generated by the first generation unit to an external apparatus; and
a determination unit that determines whether the external apparatus is safe with respect to a predetermined criterion,
wherein the acquisition unit acquires the third document resulting from execution of a process to the second document by the external apparatus, and
wherein the first generation unit generates the second document having the content of the first document if the determination unit determines that the external apparatus is safe with respect to the predetermined criterion and generates the second document having the content resulting from deletion of the first information from the first document if the determination unit determines that the external apparatus is not safe with respect to the predetermined criterion.

7. The information processing apparatus according to claim 3, further comprising:
a transmission unit that transmits the second document generated by the first generation unit to an external apparatus; and
a determination unit that determines whether the external apparatus is safe with respect to a predetermined criterion,
wherein the acquisition unit acquires the third document resulting from execution of a process to the second document by the external apparatus, and
wherein the first generation unit generates the second document having the content of the first document if the determination unit determines that the external apparatus is safe with respect to the predetermined criterion and generates the second document having the content resulting from deletion of the first information from the first document if the determination unit determines that the external apparatus is not safe with respect to the predetermined criterion.

8. An information processing apparatus comprising:
a first generation unit that generates a second document resulting from deletion of first information allocated at a first position from a first document;
an acquisition unit that acquires a third document resulting from execution of a process to the second document generated by the first generation unit;
an identification unit that identifies a second position corresponding to the first position of the first document in the third document; and
a second generation unit that generates a fourth document in which information acquired by the information processing apparatus that executes the process to the first information is allocated at the second position identified by the identification unit in the third document acquired by the acquisition unit.

9. An information processing system comprising:
a server apparatus that executes a process to a document; and
an information processing apparatus that transmits a document to the server apparatus to acquire a document resulting from execution of the process by the server apparatus,
wherein the information processing apparatus includes
a first generation unit that generates a second document resulting from deletion of first information allocated at a first position from a first document;
a transmission unit that transmits the second document generated by the first generation unit to the server apparatus;
an acquisition unit that acquires a third document resulting from execution of a process to the second document by the server apparatus;
an identification unit that identifies a second position corresponding to the first position of the first document in the third document; and
a second generation unit that generates a fourth document in which the first information is allocated at the second position identified by the identification unit in the third document acquired by the acquisition unit.
